(19) United States
(12) Patent Application Publication
(10) Pub. No.: US 2026/0222075 A1
(43) Pub. Date: Jul. 30, 2026

(54) OPTICAL RECEIVER, OPTICAL MONITOR SYSTEM, AND OPTICAL RECEPTION METHOD

(71) Applicant: NEC Corporation, Tokyo (JP)

(72) Inventor: Tatsuya YAMAZAKI, Tokyo (JP)

(73) Assignee: NEC Corporation, Tokyo (JP)

(21) Appl. No.: 19/148,438

(22) PCT Filed: Mar. 24, 2023
(86) PCT No.: PCT/JP2023/011716

§ 371 Date: Jul. 16, 2025

(51) Int. Cl. H04B 10/60; H04B 10/25; H04J 14/02

(52) U.S. Cl. CPC H04B 10/60; H04B 10/25; H04J 14/02

(57) ABSTRACT

An optical receiver includes: a first optical connection circuit that outputs first response light with an optical level in a first range containing a first response signal multiplexed by intensity-modulation of WDM light to a first path, and outputs second response light with an optical level in a second non-overlapping range containing a second response signal multiplexed by intensity-modulation of a different wavelength carrier to a second path; a photoelectric conversion circuit capable of outputting a response signal only within the first range, not the second range; a level adjustment circuit in the second path adjusts the optical level of light containing the second response signal to enable output from the photoelectric conversion circuit; and a second optical connection circuit inputs either the first response light from the first path or the adjusted light from the second path into the photoelectric conversion circuit.

### TECHNICAL FIELD

The present invention relates to an optical receiver and the like.

### BACKGROUND ART

An optical submarine cable system includes a branch unit (BU) and an optical add drop multiplexer (OADM) that are installed on the sea floor. Some of optical submarine devices as described above have a function of receiving control light transmitted by a land device and returning response light to the land device. The response light is a signal including a response signal. The response signal is response data to control light, and is multiplexed with a main signal including user data and transmitted. The main signal is an optical signal including user data, and mainly uses wavelength division multiplexing (WDM) signal light. The wavelength division multiplexing signal light is referred to below as “WDM light”. As a method for multiplexing a response signal with a main signal, two types below are known.

A first modulation method is for modulating intensity of a drive current of an excitation laser diode using a response signal in an optical submarine device. The excitation laser diode is a light source used in an optical amplifier that amplifies WDM light. This method is performed to modulate intensity of WDM light in its entire band using the response signal, the WDM light propagating through the optical submarine cable system. This modulation method is referred to below as a “full-wave modulation method”, and an optical signal generated by the full-wave modulation method is referred to as a “full-wave modulation signal”. The full-wave modulation method has a modulation degree of several percent (%) to suppress influence of modulation on transmission quality of the main signal. The modulation degree is a ratio between power A of the response signal included in power of modulated light and power B of unmodulated light, that is, A/B.

A second modulation method uses a dedicated optical carrier used only for transmission of a response signal to modulate intensity of the optical carrier using the response signal. The optical carrier is subjected to wavelength division multiplexing with WDM light and transmitted. This modulation method is referred to below as a “single wavelength modulation method”, and an optical signal generated by the single wavelength modulation method is referred to as a “single wavelength modulation signal”. The optical carrier used to generate the single wavelength modulation signal is referred to below as a “response carrier”. The optical carrier used in the single wavelength modulation method has a wavelength different from that of the WDM light, and the wavelength can be demultiplexed from the WDM light by using an optical filter or the like. The single wavelength modulation does not cause the WDM light to be affected by modulation, so that the modulation degree of the response carrier can be increased to higher than that of the full-wave modulation method. For example, the response carrier of the single wavelength modulation signal has a modulation degree of several tens %.

The full-wave modulation signal and the single-wavelength modulation signal each include a response signal from the optical submarine device. The full-wave modulation signal and the single-wavelength modulation signal will be collectively referred to below as “response light”. Depending on a configuration of the optical submarine cable system, the two types of response light described above may be used in a mixed manner.

In relation to the present invention, PTL 1 describes a wavelength division multiplexing transmission device having a function of adjusting a level of an optical signal output from an optical amplifier.

### CITATION LIST

### Patent Literature

PTL 1: JP 10-341206 A

### SUMMARY OF INVENTION

### Technical Problem

The response carrier is multiplexed with WDM light in the single-wavelength modulation method, and is transmitted from the optical submarine device to the land device. Thus, even when the response carrier included in the single wavelength modulation signal has a modulation degree of about 40%, the entire single-wavelength modulation signal including the WDM light has a modulation degree lower than that, e.g., a modulation factor less than 1%. For example, when a single-wavelength modulation signal is received using a photoelectric conversion circuit designed for a full-wave modulation signal having a modulation degree of about 4%, power of the response carrier out of power of the single-wavelength modulation signal falls below a level that can be received by the photoelectric conversion circuit, and thus the response signal may not be demodulated.

For this reason, a general optical receiver is required to prepare a photoelectric conversion circuit different in accordance with a modulation method when the full-wave modulation method and the single-wavelength modulation method are used in a mixed manner to transmit response light. Specifically, not only a photoelectric conversion circuit designed to conform to a reception level of the full-wave modulation signal, but also another photoelectric conversion circuit designed to conform to a reception level of the single-wavelength modulation signal is required to be prepared. The photoelectric conversion circuit for the single-wavelength modulation signal is optimized at a lower reception level so that the response signal can be demodulated even from response light of the single-wavelength modulation method, the response light having a low modulation degree. That is, when the full-wave modulation method and the single-wavelength modulation method are used in a mixed manner in a general optical receiver, two types of photoelectric conversion circuits are required to be prepared for the respective methods, and thus causing the photoelectric conversion circuit to be complicated and increased in size. That is, a general optical receiver in which the full-wave modulation method and the single-wavelength modulation method are used in a mixed manner has a problem of a large scale.

### OBJECT OF INVENTION

It is an object of the present invention to provide a technique capable of suppressing an increase in scale of an optical receiver that processes a plurality of pieces of response light in which response signals are multiplexed by different multiplexing methods.

### Solution to Problem

An optical receiver of the present invention includes
a first optical connection means for outputting not only first response light having an optical level in a first range and including a first response signal multiplexed by modulating intensity of WDM light to a first path, but also second response light having an optical level in a second range without overlapping the first range and including a second response signal multiplexed by modulating intensity of an optical carrier having a wavelength different from that of the WDM light to a second path,
a photoelectric conversion means having an optical reception level for allowing output of a response signal from received light, the optical reception level being within the first range and out of the second range,
a level adjustment means provided in the second path for adjusting an optical level of light including the second response signal to output the second response signal from the photoelectric conversion means, and
a second optical connection means for inputting any one of the first response light output through the first path and the light output through the second path into the photoelectric conversion means.

An optical reception method of the present invention includes a procedure of:
outputting first response light to a first path, the first response light having an optical level in a first range and including a first response signal multiplexed by modulating intensity of WDM light;
outputting second response light having an optical level in a second range without overlapping the first range and including a second response signal multiplexed by modulating intensity of an optical carrier having a wavelength different from that of the WDM light to a second path;
adjusting an optical level of light including the second response signal to allow the second response signal to be output from a photoelectric conversion means provided in the second path and having an optical reception level allowing a response signal to be output from light received, the optical reception level being in the first range and out of the second range;
inputting any one of the first response light output from the first path and the light output from the second path into the photoelectric conversion means; and
outputting the response signal from the photoelectric conversion means.

### Advantageous Effects of Invention

The present invention can suppress an increase in scale of an optical receiver that processes a plurality of pieces of response light including response signals multiplexed by different multiplexing methods.

### BRIEF DESCRIPTION OF DRAWINGS

FIG. 1 is a diagram illustrating a configuration example of an optical receiver according to a first example embodiment.

FIG. 2 is a diagram illustrating a configuration example of an optical monitoring system according to a second example embodiment.

FIG. 3 is a diagram for illustrating a level adjustment circuit.

FIG. 4 is a diagram illustrating a configuration example of a monitoring control device.

FIG. 5 is a diagram illustrating a configuration example of an optical monitoring system according to a first modification of the second example embodiment.

FIG. 6 is a diagram illustrating a configuration example of an optical monitoring system according to a second modification of the second example embodiment.

FIG. 7 is a diagram illustrating a configuration example of an optical monitoring system according to a third example embodiment.

FIG. 8 is a diagram illustrating a configuration example of an optical monitoring system according to a fourth example embodiment.

FIG. 9 is a diagram illustrating a configuration example of an optical monitoring system according to a fifth example embodiment.

### EXAMPLE EMBODIMENT

Example embodiments of the present disclosure will be described below in detail with reference to the drawings. Arrows illustrated in the drawings illustrate directions of signals and the like, and do not intend to limit properties of signals and the like. The example embodiments and the drawings indicate previously described components used in common with identical reference numerals, and duplicated description may not be described or may be simplified.

### First Example Embodiment

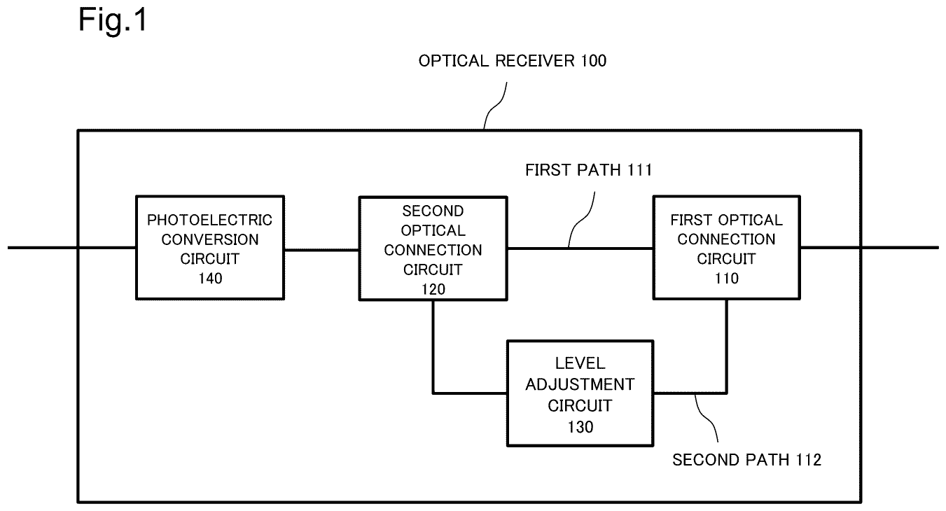

FIG. 1 is a diagram illustrating a configuration example of an optical receiver 100 according to a first example embodiment of the present invention. The optical receiver 100 includes a first optical connection circuit 110, a second optical connection circuit 120, a level adjustment circuit 130, and a photoelectric conversion circuit (optical/electrical converter, O/E) 140.

The first optical connection circuit 110 receives response light from the outside of the optical receiver 100. The response light is first response light or second response light. The first response light includes a first response signal multiplexed by modulating intensity of wavelength division multiplexing (WDM) light. The second response light is acquired by multiplexing a second response signal. The second response signal is multiplexed with the WDM light by modulating intensity of an optical carrier having a wavelength different from that of the WDM light. The first response light has an optical level in a first range and the second response light has an optical level in a second range. The first range does not overlap the second range. The first response signal and the second response signal can be collectively referred to as a response signal. The response signal indicates a processing result in an external optical communication device connected to the optical receiver 100, for example, but is not limited thereto. The external optical communication device is an optical submarine device that transmits user data using WDM light, for example, and is a BU or an OADM, for example. The first optical connection circuit 110 is a form of an optical connection means, and can be referred to as a first optical connection means.

Between the first optical connection circuit 110 and the second optical connection circuit 120, a first path 111 and a second path 112 are disposed in parallel. The second optical connection circuit 120 outputs one of light received through the first path 111 and light received through the second path 112 to a photoelectric conversion circuit 140. The second optical connection circuit 120 is a form of an optical connection means, and can be referred to as a second optical connection means.

The photoelectric conversion circuit 140 receives light from the second optical connection circuit 120, and outputs a response signal included in the received light to the outside of the optical receiver 100 as an electrical signal. The photoelectric conversion circuit 140 has a range (referred to below as a “dynamic range”) of an optical reception level in which a response signal can be output from response light, the range being in the first range and out of the second range. That is, the photoelectric conversion circuit 140 has the dynamic range in which the response signal can be output from the received light, the dynamic range being in the first range and out of the second range. The photoelectric conversion circuit 120 having such a function is a form of a photoelectric conversion means.

The second path 112 includes a level adjustment circuit 130. The level adjustment circuit 130 adjusts an optical level of light including the second response signal so that the second response signal can be output from the photoelectric conversion circuit 140. The level adjustment circuit 130 is a form of a level adjustment means.

The optical receiver 100 with a configuration as described above can suppress increase in scale of an optical receiver that receives optical signals in which response signals are multiplexed by different multiplexing methods. The reason is that the level adjustment circuit 130 adjusts a level of a received optical signal to enable the second response signal to be demodulated in the photoelectric conversion circuit 140. That is because the configuration as described above enables the second response signal to be demodulated from the second response light by using the photoelectric conversion circuit 140 with a reception level adjusted to enable the first response signal to be demodulated from the first response light.

### Second Example Embodiment

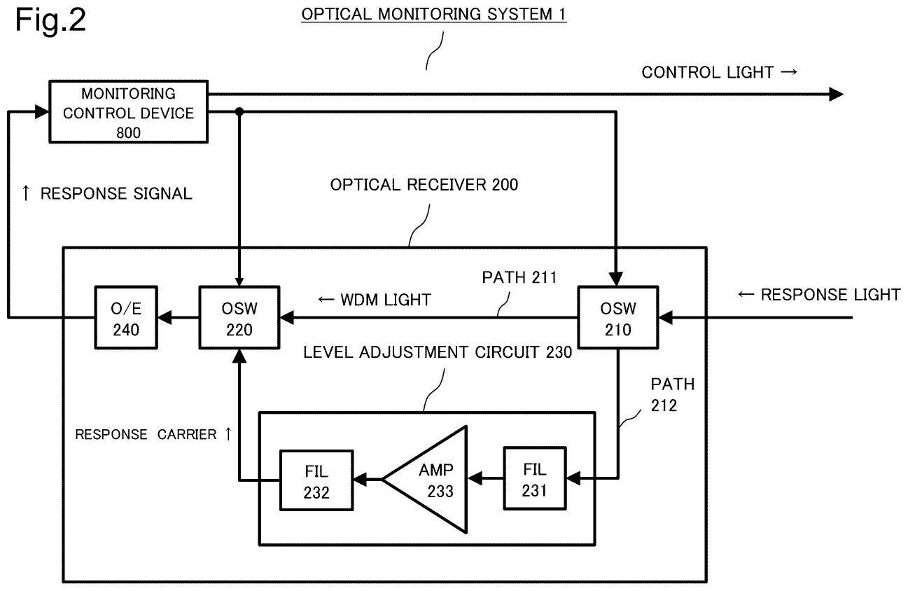

FIG. 2 is a diagram illustrating a configuration example of an optical monitoring system 1 according to a second example embodiment of the present invention. The optical monitoring system 1 includes an optical receiver 200 and a monitoring control device 800. The optical receiver 200 includes optical switches (OSWs) 210 and 220, a level adjustment circuit 230, and a photoelectric conversion circuit (O/E) 240. Hereinafter, an “optical level” is simply referred to as a “level”.

The optical switches 210 and 220 are each a “1×2” optical switch. The optical switch 210 includes a common port that receives response light from the outside of the optical receiver 200. The response light is an optical signal including a response signal, and is a full-wave modulation signal or a single-wavelength modulation signal transmitted by an optical communication device (not illustrated). The optical communication device is an optical submarine device such as a BU or an OADM. When receiving control light transmitted by the monitoring control device 800, the optical communication device returns response light to the optical receiver 200. The control light includes a control signal that controls the optical communication apparatus and requests a response signal to be returned. The response light includes the response signal to be returned to the control signal, the response signal being multiplexed by a full-wave modulation method or a single-wavelength modulation method. The full-wave modulation method is for modulating intensity of WDM light using a response signal. The single-wavelength modulation method for modulating intensity of an optical carrier (response carrier) having a wavelength different from that of the WDM light using a response signal. The optical receiver in each example embodiment of the present application does not simultaneously receive a full-wave modulation signal and a single-wavelength modulation signal. Whether the response light is the full-wave modulation signal or the single-wavelength modulation signal is different for each optical communication device.

The common port of the optical switch 210 is connected to an optical transmission device installed outside the optical receiver 200. When the optical receiver 200 receives response light from the outside, the response light being a full-wave modulation signal, the optical switch 210 outputs the response light to the path 211. When the response light is a single-wavelength modulation signal, the optical switch 210 outputs the response light to the path 212.

The optical switch 220 includes a common port connected to the photoelectric conversion circuit 240. When the response light is a full-wave modulation signal, the optical switch 220 connects the path 212 to the photoelectric conversion circuit 240. When the response light is a single-wavelength modulation signal, the optical switch 220 connects output of the level adjustment circuit 230 to the photoelectric conversion circuit 240.

The path 211 is an optical path that directly connects the optical switch 210 to the optical switch 220. The path 211 is provided with no optical circuit that changes properties of light propagating. In contrast, the path 212 is an optical path that connects the optical switch 210 to the optical switch 220 through the level adjustment circuit 230. The level adjustment circuit 230 performs processing for enabling the photoelectric conversion circuit 240 to demodulate the response signal on the input single wavelength modulation signal. The level adjustment circuit 230 will be described later.

The photoelectric conversion circuit 240 converts light received through the path 211 or the path 212 switched by the optical switch 220 into an electrical signal, and demodulates a response signal included in the light. The photoelectric conversion circuit 240 has a dynamic range adjusted to enable a response signal to be demodulated over the entire fluctuation range of power of a full-wave modulation signal received from the optical switch 220. Meanwhile, the dynamic range of the photoelectric conversion circuit 240 is not necessarily optimized to enable a response signal to be demodulated over a fluctuation range of power of a response carrier of a single-wavelength modulation signal received from the optical switch 220. The single-wavelength modulation signal includes the response signal superimposed on only one response carrier, so that power of the response signal in power of the response carrier is smaller than power of the response signal superimposed on the WDM light in the full-wave modulation signal. For example, even when the full-wave modulation signal has a modulation degree of 4% and the response carrier of the single-wavelength modulation signal has a modulation degree of 40%, the response signal included in the single-wavelength signal may have optical power converted into a modulation degree of 1% or less in the full-wave modulation signal. When the photoelectric conversion circuit 240 optimized to receive the full-wave modulation signal is used at the modulation degree, the response signal may not be demodulated from the response carrier of the single-wavelength modulation signal.

Thus, the optical receiver 200 of the present example embodiment uses the level adjustment circuit 230 to amplify the response carrier of the single-wavelength modulation signal. Amplifying the response carrier enables the photoelectric conversion circuit 240 to demodulate the response signal from not only the WDM light but also the response carrier within the dynamic range of the photoelectric conversion circuit 240. The demodulated response signal is output to the outside of the optical receiver 200. The response signal may be input to the monitoring control device 800.

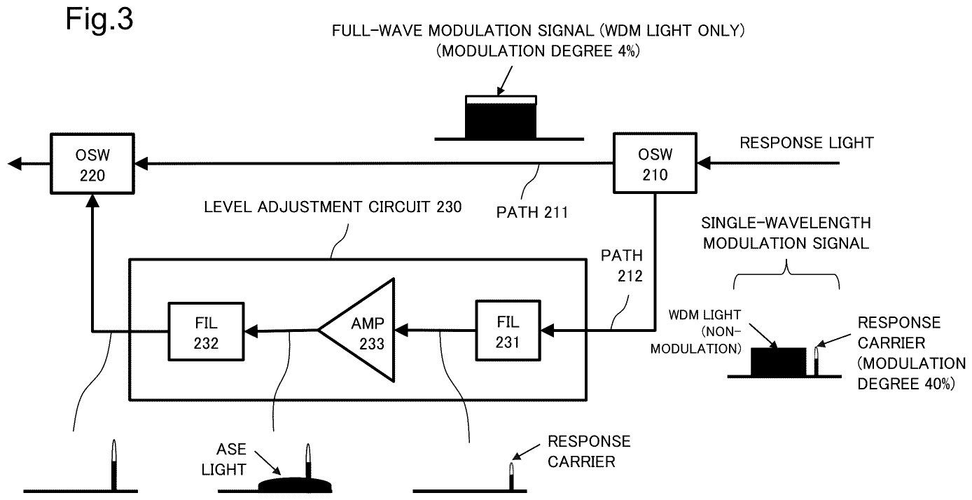

FIG. 3 is a diagram for illustrating the level adjustment circuit 230. The level adjustment circuit 230 includes optical filters (filter, FIL) 231 and 232, and an optical amplifier (amplifier, AMP) 233. FIG. 3 schematically illustrates an example of a spectrum of light output from the optical switch 210 with a horizontal axis indicating a wavelength and a vertical axis indicating a level (power). The example of the spectrum shows a part in white that schematically indicates that the spectrum varies in intensity as a result of intensity modulation with the response signal. When the response light is a single-wavelength modulation signal, the optical switch 210 outputs the response light to the path 212, and the optical switch 220 connects the optical switch 210 to the path 212.

The optical filter 231 removes the WDM light from the single-wavelength modulation signal received from the optical switch 210 and outputs only the response carrier modulated by the response signal. The response carrier is different in a wavelength from the WDM light, so that the optical filter 231 can separate only the response carrier from the response light using a dielectric multilayer film or the like. The response carrier is amplified by the optical amplifier 233. The optical amplifier 233 has gain set to enable the photoelectric conversion circuit 240 to demodulate the response signal from the response carrier.

The optical filter 232 is a narrowband optical band-pass filter, and removes amplified spontaneous emission (ASE) generated in the optical amplifier 233. Using the optical filter 232 enables reducing influence of noise due to ASE light during demodulation of the response signal. The optical filter 232 may not be provided when the ASE light has power to the extent that the demodulated response signal is not affected in quality.

As described above, the optical switches 210 and 220 select the path 211 when the optical switch 210 receives an optical signal of a full-wave modulation signal, and select the path 212 when the optical switch 210 receives an optical signal of a single-wavelength modulation signal. As described below, the monitoring control device 800 may perform control (switching instruction) on the optical switches 210 and 220.

The monitoring control device 800 transmits a control signal for the optical communication device as control light, and the optical communication device having received the control light generates a response signal indicating contents (e.g., execution results of the control) associated with the control signal included in the control light. The response signal is converted into response light using the full-wave modulation method or the single-wavelength modulation method in the optical communication device and transmitted to the optical receiver 200.

The monitoring control device 800 also holds information on timing at which the control light is transmitted to each optical transmission device. In the optical communication device, reception of the control light triggers transmission of the response light. The monitoring control device 800 also holds information on the modulation method of the response light for each optical communication device that transmits the response light. Thus, the monitoring control device 800 transmits a switching instruction for switching the optical switches 210 and 220 to the optical receiver 200 in accordance with the modulation method of the response light of the optical communication device to be a transmission destination of the control light. The switching instruction is transmitted before the optical receiver 200 receives the response light from the optical communication device. In accordance with control as described above, the optical receiver 200 can select the path 211 or 212 in accordance with the modulation method of the response light when receiving the response light corresponding to the control light.

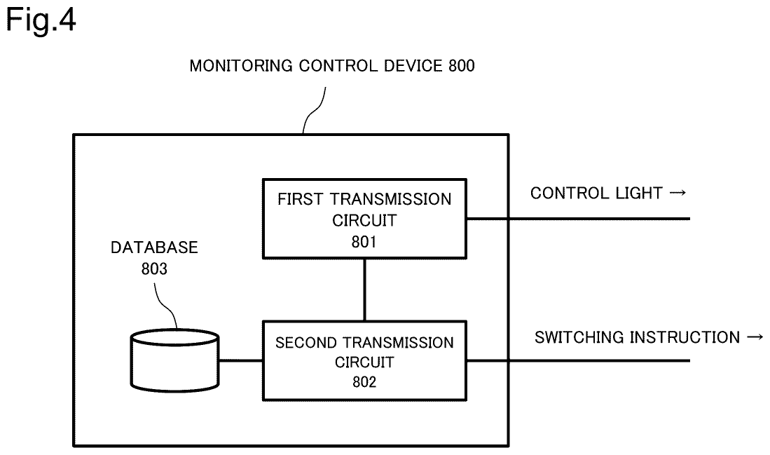

FIG. 4 is a diagram illustrating a configuration example of the monitoring control device 800. The monitoring control device 800 includes a first transmission circuit 801, a second transmission circuit 802, and a database 803. The first transmission circuit 801 transmits control light to the optical transmission device. The control light is an optical signal including an instruction to request transmission of a full-wave modulation signal (first response light) or transmission of a single-wavelength modulation signal (second response light). The database 803 stores a correspondence between the optical transmission device and a type of the response light (whether the response light is a full-wave modulation signal or a single-wavelength modulation signal). The database 803 also stores timing of transmission of the control light. The second transmission circuit 802 transmits an instruction to switch the optical switches 210 and 220 to the optical receiver 200. The switching instruction is transmitted before the response light from the optical communication device reaches the optical receiver 200. Consequently, the optical receiver 200 can distribute the response light to the path 211 or the path 212 in accordance with the type of the response light. The first transmission circuit 801 and the second transmission circuit 802 are each a form of a transmission means. The first transmission circuit 801 can be referred to as a first transmission means, and the second transmission circuit 802 can be referred to as a second transmission means.

There is a conceivable case in which an optical communication device to be a transmission destination of control light of the monitoring control device 800 transmits a response signal to the control light to the optical receiver 200 by the full-wave modulation method. In this case, the monitoring control device 800 switches the optical switches 210 and 220 toward the path 211 before the optical receiver 200 receives the response light to the control light transmitted. The response light is a full-wave modulation signal, so the photoelectric conversion circuit 240 can demodulate the response signal by directly converting the response light by photoelectric conversion.

Meanwhile, there is a conceivable case in which an optical communication device to be a transmission destination of control light of the monitoring control device 800 transmits a response signal to the control light to the optical receiver 200 by the single-wavelength modulation method. In this case, the monitoring control device 800 switches the optical switches 210 and 220 toward the path 212 before the response light reaches the optical receiver 200. Consequently, the response carrier is amplified in the level adjustment circuit 230. The optical amplifier 233 causes the response carrier to have power with a value within the dynamic range of the photoelectric conversion circuit 240. Thus, the photoelectric conversion circuit 240 can demodulate the response signal by converting the amplified response carrier by the photoelectric conversion.

As described above, the optical receiver 200 and the optical monitoring system 1 including the optical receiver can suppress an increase in scale of an optical receiver that processes a plurality of pieces of response light including response signals multiplexed by different multiplexing methods. When the optical receiver 200 transmits the response signal demodulated in the photoelectric conversion circuit 240 to the monitoring control device 800, the database 803 may store the received response signal. This effect can be similarly obtained also in a first modification and a second modification below.

### First modification of second example embodiment

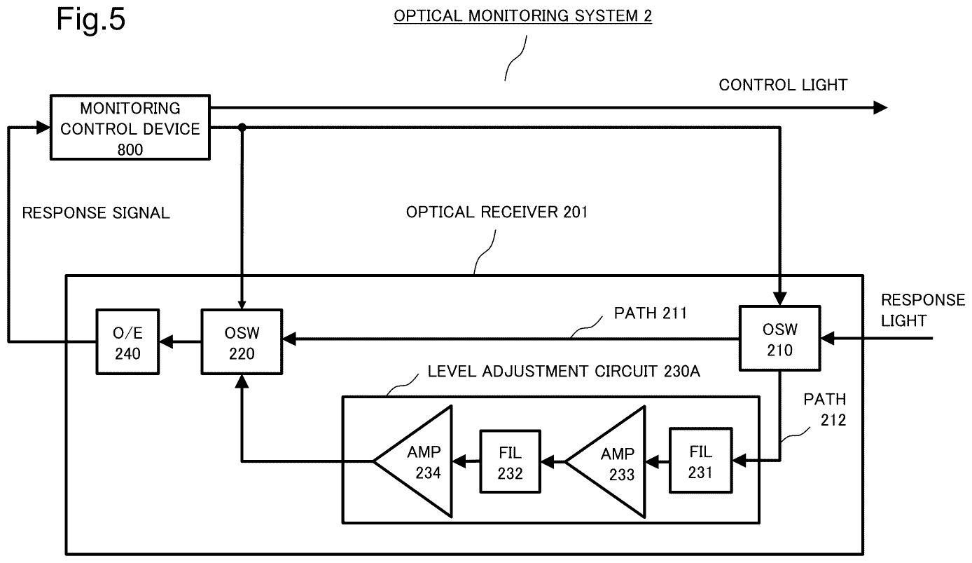

FIG. 5 is a diagram illustrating a configuration example of an optical monitoring system 2 according to a first modification of the second example embodiment of the present invention. The optical monitoring system 2 includes an optical receiver 201 instead of the optical receiver 200 of the optical monitoring system 1. The optical receiver 201 is different from the optical receiver 200 in that a level adjustment circuit 230A is provided instead of the level adjustment circuit 230.

The level adjustment circuit 230A includes optical filters 231 and 232, and optical amplifiers 233 and 234. When the response light received from the outside of the optical receiver 201 is a single-wavelength modulation signal, the optical switch 210 switches the optical path to the path 212 to cause the response light to be input to the level adjustment circuit 230A. The optical filter 231, the optical amplifier 233, and the optical filter 232 of the level adjustment circuit 230 have functions similar to those illustrated in FIG. 3.

The level adjustment circuit 230A amplifies the response carrier output from the optical filter 232 using the optical amplifiers 233 and 234. The optical receiver 201 includes the optical amplifier 234 in addition to the optical amplifier 233, so that the response carrier can be further amplified even when gain is insufficient only with the optical amplifier 233. The amplified response carrier is input to the optical switch 220. As a result, even when the response carrier level is lower, for example, the response signal can be demodulated from the single wavelength modulation signal in the photoelectric conversion circuit 240. The level adjustment circuit 230A may include an optical filter at output of the optical amplifier 234 to remove ASE light generated in the optical amplifier 234.

### Second Modification of Second Example Embodiment

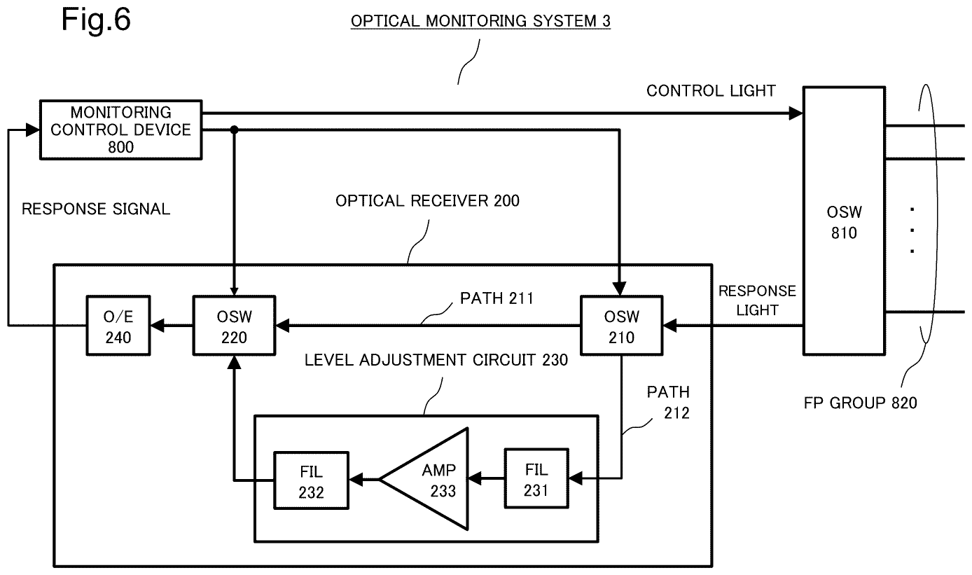

FIG. 6 is a diagram illustrating a configuration example of an optical monitoring system 3 according to a second modification of the second example embodiment of the present invention. The optical monitoring system 3 is different from the optical monitoring system 1 illustrated in FIG. 2 in that an optical switch 810 is provided.

The optical switch 810 selects a downstream optical fiber that transmits control light transmitted from the monitoring control device 800 to the optical communication device and an upstream optical fiber that transmits response light to the control light. The optical switch 810 is connected to a plurality of optical communication devices, and each optical communication device and the optical switch 810 are connected using a fiber pair (fiber pair, FP). One fiber pair includes two optical fibers. One of the two optical fibers is used as the downstream optical fiber and the other is used as the upstream optical fiber. These fiber pairs are connected to the optical switch 810 as an FP group 820. The optical switch 810 selects an optical communication device to be controlled in units of a fiber pair. The control light transmitted by the monitoring control device 800 is transmitted to the optical transmission device to be controlled through one optical fiber of the selected fiber pair. The optical transmission device having received the control light transmits the response light to the optical receiver 200 through the other optical fiber of the selected fiber pair.

The optical monitoring system 3 provided with the optical switch 810 can transmit control light to each of the plurality of optical communication devices and receive response light from each of the optical communication devices.

### Third example embodiment

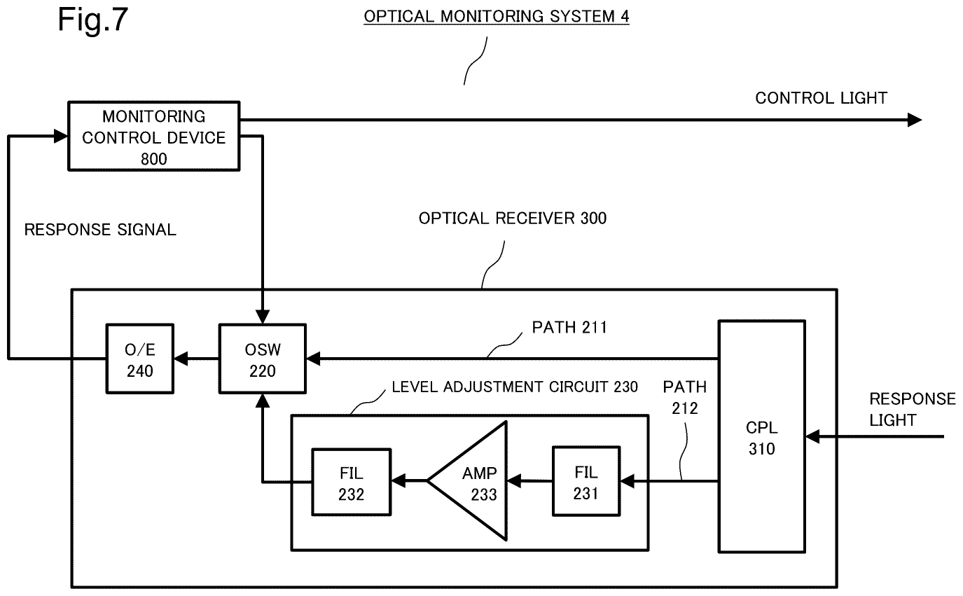

FIG. 7 is a diagram illustrating a configuration example of an optical monitoring system 4 according to a third example embodiment of the present invention. The optical monitoring system 4 includes an optical receiver 300 and a monitoring control device 800. As compared with the optical receiver 200, the optical receiver 300 includes an optical coupler (CPL) 310 instead of the optical switch 210. That is, the optical receiver 300 includes an optical coupler 310, an optical switch 220, a level adjustment circuit 230, and a photoelectric conversion circuit 240. The optical switch 220, the level adjustment circuit 230, and the photoelectric conversion circuit 240 are similar in configuration and function to those of the optical receiver 200.

The optical coupler 310 is a “1×2” optical coupler having a splitting ratio of “1:1”. The optical coupler 310 receives response light from the outside of the optical receiver 300. Regardless of whether the received response light is the full-wave modulation signal or the single-wavelength modulation signal, the optical coupler 310 outputs the signal to both the paths 211 and 212 with power in accordance with the splitting ratio of the optical coupler 310.

The level adjustment circuit 230 blocks a wavelength of the WDM light, and transmits and amplifies only a wavelength of the response carrier. Thus, even when the response light received from the optical coupler 310 is a full-wave modulation signal, the WDM light subjected to full-wave modulation is not output from the level adjustment circuit 230.

When the received response light is a full-wave modulation signal, the optical switch 220 inputs light having propagated through the path 211 to the photoelectric conversion circuit 240. When the received response light is a single-wavelength modulation signal, the optical switch 220 inputs light output from the level adjustment circuit 230 to the photoelectric conversion circuit 240. The optical switch 220 may be controlled by the monitoring control device 800.

The optical monitoring system 4 and the optical receiver 300, which have a configuration as described above, can suppress increase in scale of an optical receiver that receives optical signals in which response signals are multiplexed by different multiplexing methods. The reason is that the level adjustment circuit 230 adjusts a level of a received optical signal to enable the second response signal to be demodulated in the photoelectric conversion circuit 240.

The optical receiver 300 includes only one optical switch. Thus, the optical switch and the control circuit thereof can be simplified in configuration as compared with the optical receiver 200 including two optical switches. Instead of the level adjustment circuit 230, the level adjustment circuit 230A provided in the optical receiver 201 may be used.

### Fourth example embodiment

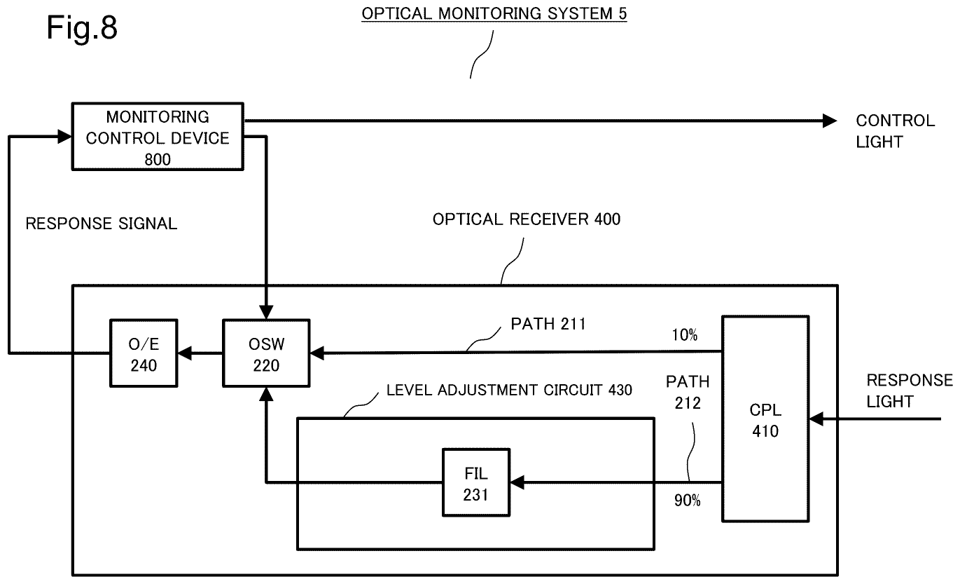

FIG. 8 is a diagram illustrating a configuration example of an optical monitoring system 5 according to a fourth example embodiment of the present invention. The optical monitoring system 5 includes an optical receiver 400 and a monitoring control device 800. The optical receiver 400 includes an optical coupler 410, an optical switch 220, a level adjustment circuit 430, and a photoelectric conversion circuit 240. As compared with the optical receiver 300, the optical receiver 400 includes the optical coupler 410 instead of the optical coupler 310 and the level adjustment circuit 430 instead of the level adjustment circuit 230. The optical switch 220 and the photoelectric conversion circuit 240 are similar in configuration and function to those of the optical receivers 200 and 300.

The optical coupler 410 is a “1×2” optical coupler that is unequally split. Although the optical coupler 410 of the present embodiment is an optical coupler (10 dB optical coupler) having a splitting ratio of “90%: 10%”, the splitting ratio is not limited thereto. The optical coupler 410 receives response light from the outside of the optical receiver 400. Regardless of whether the received response light is the full-wave modulation signal or the single-wavelength modulation signal, the optical coupler 410 outputs the signal to both the paths 211 and 212. The optical coupler 410 has a split side including a small splitting ratio side (i.e., a large split loss side) connected to the path 211, and a large splitting ratio side (i.e., a small split loss side) connected to the path 212. The optical coupler 410 in the present example embodiment is a 10 dB optical coupler. Thus, the optical coupler 410 has a passage loss of about 10 dB from its input side to the path 211, and a passage loss of about 0.5 dB from the input side to the path 212.

The level adjustment circuit 430 includes an optical filter 231. The optical filter 231 transmits only light of a wavelength of a response carrier. Thus, when the response light is a full-wave modulation signal, the optical filter 231 blocks WDM light subjected to full-wave modulation. The level adjustment circuit 430 does not include an optical amplifier, so that the response carrier output from the optical filter 231 is input to the optical switch 220 without being amplified.

The optical switch 220 is similar in operation to that of each of the optical receivers 200 and 300. When the response light received by the optical receiver 400 is a full-wave modulation signal, the optical switch 220 inputs light having propagated through the path 211 to the photoelectric conversion circuit 240. When the response light is a single-wavelength modulation signal, the optical switch 220 inputs the response carrier having propagated through the path 212 to the photoelectric conversion circuit 240. The optical switch 220 may be controlled by the monitoring control device 800.

The optical coupler 410 in the present example embodiment is an unequally split optical coupler. Thus, the response light split into the path 211 is different in power from the response light split into the path 212. In the present example embodiment, a split loss to the path 212 having a large splitting ratio is smaller than a split loss to the path 211 by about 9 dB. Thus, a difference between power of the response carrier received by the level adjustment circuit 430 and power of a full-wave modulation signal when the full-wave modulation signal propagates through the path 211 is reduced by about 9 dB as compared with that in the configuration using the optical switch 210 exemplified in the second example embodiment and the like. That is, the optical receiver 400 can reduce the difference between the power of the full-wave modulation signal to be received by the photoelectric conversion circuit 240 and the power of the response carrier by using the optical coupler 410. As a result, when both of these powers fall within the dynamic range of the photoelectric conversion circuit 240, the response signal can be demodulated not only from the full-wave modulation signal but also from the response carrier by using the photoelectric conversion circuit 240 having the dynamic range for receiving the full-wave modulation signal. The splitting ratio of the optical coupler 410 is set to enable the photoelectric conversion circuit 240 to demodulate the response signal regardless of whether the response light is the full-wave modulation signal or the single-wavelength modulation signal.

As with the optical receiver 300, the optical receiver 400 may have only one optical switch. Thus, the control circuit can be simplified as compared with the optical receiver 200. The optical receiver 400 also can reduce the difference between the power of the response carrier of the single-wavelength modulation signal to be received by the photoelectric conversion circuit 240 and the power of the full-wave modulation signal by using the optical coupler 410 that is an unequally split optical coupler. Thus, the optical receiver 400 can demodulate the response signal without providing an optical amplifier in the level adjustment circuit 430. The optical receiver 400 distributes the response light at a higher level than that of the path 211 to the path 212 using the optical coupler 410. That is, the optical coupler 410 functions as the level adjustment circuit 130 described in FIG. 1. The optical monitoring system 5 and the optical receiver 400, which have a configuration as described above, can suppress increase in scale of an optical receiver that receives optical signals in which response signals are multiplexed by different multiplexing methods.

### Fifth example embodiment

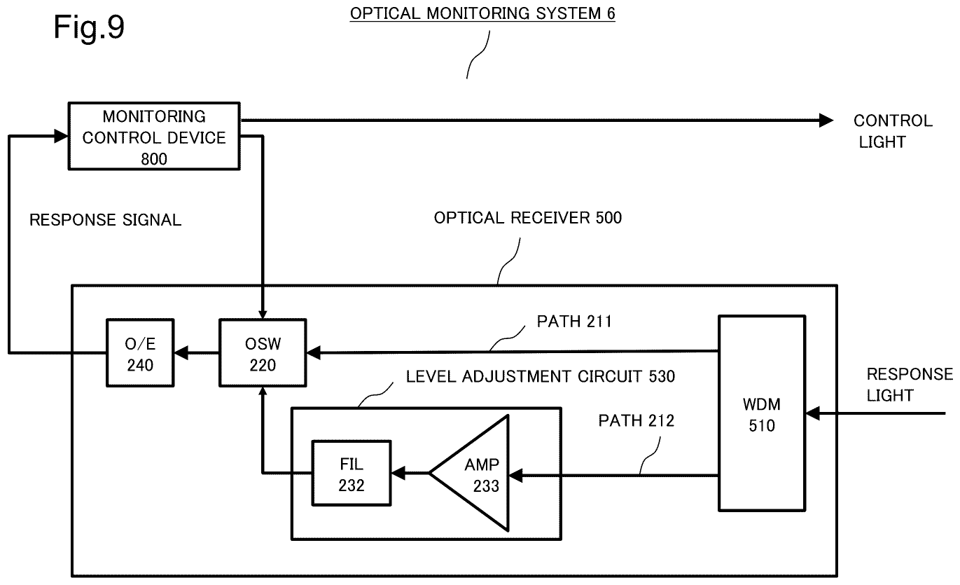

FIG. 9 is a diagram illustrating a configuration example of an optical monitoring system 6 according to a fifth example embodiment of the present invention. The optical monitoring system 6 includes an optical receiver 500 and a monitoring control device 800. The optical receiver 500 includes a WDM filter 510, an optical switch 220, a level adjustment circuit 530, and a photoelectric conversion circuit 240. As compared with the optical receiver 200, the optical receiver 500 includes the WDM filter 510 instead of the optical switch 210 and the level adjustment circuit 530 instead of the level adjustment circuit 230. The optical switch 220 and the photoelectric conversion circuit 240 are similar in configuration and function to those of the optical receiver 200.

The WDM filter 510 is an optical demultiplexer that separates received response light based on a wavelength. The WDM filter 510 may include a dielectric multilayer film filter or a wavelength selective switch (WSS). The WDM filter 510 receives response light from the outside of the optical receiver 500. The WDM filter 510 outputs light in a wavelength band of WDM light in the received response light to the path 211 and outputs light in a wavelength band of a response carrier in the received response light to the path 212. That is, an optical path from input in the WDM filter 510 to the path 211 functions as an optical band-pass filter that transmits only the wavelength of the WDM light. Then, an optical path from the input in the WDM filter 510 to the path 212 functions as an optical band-pass filter that transmits only the wavelength of the response carrier of the single-wavelength modulation signal.

The level adjustment circuit 530 includes an optical amplifier 233 and an optical filter 232. The optical amplifier 233 amplifies the response carrier separated by the WDM filter 510. The optical amplifier 233 has gain set to enable the photoelectric conversion circuit 240 to demodulate the response signal from the response carrier. The optical filter 232 removes ASE generated in the optical amplifier 233. The optical filter 232 may not be provided when ASE light has power too low to affect quality of the response signal.

The optical monitoring system 6 and the optical receiver 500, which have a configuration as described above, can suppress increase in scale of an optical receiver that receives optical signals in which response signals are multiplexed by different multiplexing methods. As with the optical receivers 300 and 400, the optical receiver 500 may have only one optical switch. Thus, the control circuit can be simplified as compared with the optical receiver 200. The WDM filter 510 also includes a function of a narrowband filter for the path 212, so that a narrowband filter is unnecessary for the level adjustment circuit 530. Thus, the level adjustment circuit 530 can be simplified in configuration.

The example embodiments of the present invention can also be described as supplementary notes below, but are not limited thereto.

### (Supplementary Note 1)

An optical receiver including:
a first optical connection means for outputting not only first response light having an optical level in a first range and including a first response signal multiplexed by modulating intensity of WDM light to a first path, but also second response light having an optical level in a second range without overlapping the first range and including a second response signal multiplexed by modulating intensity of an optical carrier having a wavelength different from that of the WDM light to a second path;
a photoelectric conversion means having an optical reception level for allowing output of a response signal from received light, the optical reception level being within the first range and out of the second range;
a level adjustment means provided in the second path for adjusting an optical level of light including the second response signal to output the second response signal from the photoelectric conversion means; and
a second optical connection means for inputting any one of the first response light output through the first path and the light output through the second path into the photoelectric conversion means.

### (Supplementary Note 2)

The optical receiver described in the Supplementary Note 1, in which
the first optical connection means and the second optical connection means each include an optical switch that selects one of the first path and the second path, and
the level adjustment means includes:
an optical filter that transmits light including the second response signal; and
an optical amplifier that amplifies light including the second response signal output from the optical filter.

### (Supplementary Note 3)

The optical receiver described in the Supplementary Note 1, in which
the first optical connection means includes an optical coupler that splits each of the first response light and the second response light into the first path and the second path,
the second optical connection means includes an optical switch that selects one of the first path and the second path, and
the level adjustment means includes:
an optical filter that transmits light including the second response signal; and
an optical amplifier that amplifies light including the second response signal output from the optical filter.

### (Supplementary Note 4)

The optical receiver described in the Supplementary Note 1, in which
the first optical connection means includes an unequally split optical coupler that splits each of the first response light and the second response light into the first path and the second path at different splitting ratios,
the second optical connection means includes an optical switch that selects one of the first path and the second path, and
the level adjustment means includes an optical filter that transmits light including the second response signal.

### (Supplementary Note 5)

The optical receiver described in the Supplementary Note 1 or 2, in which
the first optical connection means includes a demultiplexer that outputs the first response light to the first path and outputs light including the response signal included in the second response light to the second path,
the second optical connection means includes an optical switch that selects one of the first path and the second path, and
the level adjustment means includes an optical amplifier that amplifies light including the second response signal received from the demultiplexer.

### (Supplementary Note 6)

The optical receiver described in any one of the Supplementary Notes 1 to 5, in which at least one of the first optical connection means and the second optical connection means is controlled in accordance with a switching instruction from the outside.

### (Supplementary Note 7)

An optical monitoring system including:
the optical receiver described in the Supplementary Note 6 that receives the first response light and the second response light transmitted by an optical transmission device; and
a monitoring control device that transmits control light for requesting transmission of the first response light or the second response light to the optical transmission device, and transmits the switching instruction to the optical receiver.

### (Supplementary Note 8)

The optical monitoring system described in the Supplementary Note 7, further including:
an optical switch that selects a fiber pair connecting the optical receiver to the optical transmission device, in which
the monitoring control device inputs the control light into the selected fiber pair, and
the optical receiver receives the first response light or the second response light from the selected fiber pair.

### (Supplementary Note 9)

The optical monitoring system described in the Supplementary Note 7, in which
the monitoring control device includes:
a first transmission means for transmitting control light to an optical transmission device, the control light requesting transmission of the first response light or the second response light;
a database that stores a correspondence between the optical transmission device and a type of response light, and transmission timing of the control light; and
a second transmission means for transmitting a switching instruction of an optical switch provided in the optical receiver to the optical receiver before the first response light or the second response light reaches the optical receiver in accordance with the transmission timing of the control light and the correspondence between the optical transmission device and the type of the response light.

### (Supplementary Note 10)

An optical reception method including:
outputting first response light to a first path, the first response light having an optical level in a first range and including a first response signal multiplexed by modulating intensity of WDM light;
outputting second response light having an optical level in a second range without overlapping the first range and including a second response signal multiplexed by modulating intensity of an optical carrier having a wavelength different from that of the WDM light to a second path;
adjusting an optical level of light including the second response signal to allow the second response signal to be output from a photoelectric conversion means provided in the second path and having an optical reception level allowing a response signal to be output from light received, the optical reception level being in the first range and out of the second range;
inputting any one of the first response light output from the first path and the light output from the second path into the photoelectric conversion means; and
outputting the response signal from the photoelectric conversion means.

While the present invention has been particularly shown and described with reference to example embodiments thereof, the present invention is not limited to the above example embodiments. It will be understood by those of ordinary skill in the art that various changes in form and details may be made therein without departing from the spirit and scope of the present invention as defined by the claims. For example, the present invention is applicable to not only an optical submarine cable system but also an optical transmission system on land. The example embodiments also disclose corresponding example embodiments of an optical receiver, an optical monitoring system, an optical reception method, a monitoring control device, and a monitor control method.

The configurations described in the respective example embodiments are not necessarily exclusive from each other. The functions and effects of the present invention may be achieved by a configuration in which all or some of the above-described example embodiments are combined.

Some or all of the functions and procedures of the optical receiver described in each of the above example embodiments may be implemented using a program executed by a central processing unit (CPU) included in the optical receiver or the monitoring control device in each of the example embodiments. The program is recorded in a fixed tangible and non-transitory recording medium. Although a semiconductor memory or a fixed magnetic disk device is used as the recording medium, the recording medium is not limited thereto.

### REFERENCE SIGNS LIST

1-6 optical monitoring system
100, 200, 201, 300, 400, 500 optical receiver
111 first path
112 second path
130, 230, 230A, 430, 530 level adjustment circuit
140, 240 photoelectric conversion circuit
210, 220 optical switch
211, 212 path
231, 232 optical filter
233, 234 optical amplifier
310, 410 optical coupler
510 WDM filter
530 level adjustment circuit
800 monitoring control device
801 first transmission circuit
802 second transmission circuit
803 database
810 optical switch
820 FP group

What is claimed is:

1. An optical receiver comprising:
a first optical connection circuit configured to output:
first response light having an optical level in a first range and including a first response signal multiplexed by modulating intensity of wavelength division multiplexing (WDM) light to a first path; and
second response light having an optical level in a second range without overlapping the first range and including a second response signal multiplexed by modulating intensity of an optical carrier having a wavelength different from that of the WDM light to a second path;
a photoelectric conversion circuit having an optical reception level for allowing output of a response signal from received light, the optical reception level being within the first range and out of the second range;
a level adjustment circuit provided in the second path for adjusting an optical level of light including the second response signal to output the second response signal from the photoelectric conversion circuit; and
a second optical connection circuit configured to input any one of the first response light output through the first path and the light output through the second path to the photoelectric conversion circuit.

2. The optical receiver according to claim 1, wherein
the first optical connection circuit and the second optical connection circuit each include an optical switch that selects one of the first path and the second path, and
the level adjustment circuit includes:
an optical filter that transmits light including the second response signal; and
an optical amplifier that amplifies light including the second response signal output from the optical filter.

3. The optical receiver according to claim 1, wherein
the first optical connection circuit includes an optical coupler that splits each of the first response light and the second response light into the first path and the second path,
the second optical connection circuit includes an optical switch that selects one of the first path and the second path, and
the level adjustment circuit includes:
an optical filter that transmits light including the second response signal; and
an optical amplifier that amplifies light including the second response signal output from the optical filter.

4. The optical receiver according to claim 1, wherein
the first optical connection circuit includes an unequally split optical coupler that splits each of the first response light and the second response light into the first path and the second path at different splitting ratios,
the second optical connection circuit includes an optical switch that selects one of the first path and the second path, and
the level adjustment circuit includes an optical filter that transmits light including the second response signal.

5. The optical receiver according to claim 1, wherein
the first optical connection circuit includes a demultiplexer that outputs the first response light to the first path and outputs light including the response signal included in the second response light to the second path,
the second optical connection circuit includes an optical switch that selects one of the first path and the second path, and
the level adjustment circuit includes an optical amplifier that amplifies light including the second response signal received from the demultiplexer.

6. The optical receiver according to claim 1, wherein at least one of the first optical connection circuit and the second optical connection circuit is controlled in accordance with a switching instruction from the outside.

7. An optical monitoring system comprising:
an optical receiver, the optical receiver comprising:
a first optical connection circuit configured to output first response light having an optical level in a first range and including a first response signal multiplexed by modulating intensity of wavelength division multiplexing (WDM) light to a first path, and second response light having an optical level in a second range without overlapping the first range and including a second response signal multiplexed by modulating intensity of an optical carrier having a wavelength different from that of the WDM light to a second path;
a photoelectric conversion circuit having an optical reception level for allowing output of a response signal from received light, the optical reception level being within the first range and out of the second range;
a level adjustment circuit provided in the second path for adjusting an optical level of light including the second response signal to output the second response signal from the photoelectric conversion circuit; and
a second optical connection circuit configured to input any one of the first response light output through the first path and the light output through the second path to the photoelectric conversion circuit, wherein
at least one of the first optical connection circuit and the second optical connection circuit is controlled in accordance with a switching instruction from the outside, and
the optical receiver receives the first response light and the second response light transmitted by an optical transmission device; and
a monitoring control device that transmits control light for requesting transmission of the first response light or the second response light to the optical transmission device, and transmits the switching instruction to the optical receiver.

8. The optical monitoring system according to claim 7, further comprising:
an optical switch that selects a fiber pair connecting the optical receiver to the optical transmission device, wherein
the monitoring control device inputs the control light into the selected fiber pair, and
the optical receiver receives the first response light or the second response light from the selected fiber pair.

9. The optical monitoring system according to claim 7, wherein
the monitoring control device includes:
a first transmission circuit configured to transmit control light to the optical transmission device, the control light requesting transmission of the first response light or the second response light;
a database that stores a correspondence between the optical transmission device and a type of response light, and transmission timing of the control light; and
a second transmission circuit configured to transmit a switching instruction of an optical switch provided in the optical receiver to the optical receiver before the first response light or the second response light reaches the optical receiver in accordance with the transmission timing of the control light and the correspondence between the optical transmission device and the type of the response light.

10. An optical reception method comprising:
outputting first response light to a first path, the first response light having an optical level in a first range and including a first response signal multiplexed by modulating intensity of wavelength division multiplexing (WDM) light;
outputting second response light having an optical level in a second range without overlapping the first range and including a second response signal multiplexed by modulating intensity of an optical carrier having a wavelength different from that of the WDM light to a second path;
adjusting an optical level of light including the second response signal to allow the second response signal to be output from a photoelectric conversion circuit provided in the second path and having an optical reception level allowing a response signal to be output from light received, the optical reception level being in the first range and out of the second range;
inputting any one of the first response light output from the first path and the light output from the second path into the photoelectric conversion circuit; and
outputting the response signal from the photoelectric conversion circuit.
